(19) United States
(12) Patent Application Publication
(10) Pub. No.: US 2010/0162574 A1
(43) Pub. Date: Jul. 1, 2010

(54) Electric pruner

(76) Inventors: Fangjie Nie, Nanjing (CN); Toshinari Yamaoka, Nanjing (CN)

Correspondence Address: MCDERMOTT, WILL & EMERY LLP;Attn: IP Department, 227 WEST MONROE STREET, SUITE 4400, CHICAGO, IL, 60606-5096, US

(21) Appl. No.: 12/655,043

(22) Filed: Dec. 22, 2009

(30) Foreign Application Priority Data
Dec. 31, 2008 (CN) 200820238385.5

(51) Int. Cl. A01G 3/08

(52) U.S. Cl. 30/233; 30/249

(57) ABSTRACT

A pruner having a housing, a motor mounted in the housing, a handle, an upper blade, a lower blade, and a guide apparatus. The guide apparatus is a long shaped piece with a portion that has the same angle of curvature as one of the blades. The guide apparatus is longer than one of the blades to allow the guide apparatus to assist a user in selecting a specific tree limb to be cut thereby minimizing the unintentional removal of an incorrect tree limb. The guide apparatus may also be removed if the pruner is going to be used to cut lower limbs or in confined spaces.

### CROSS-REFERENCE TO RELATED APPLICATIONS

This application claims priority under 35 U.S.C. §119 to CN 200820238385.5 filed Dec. 31, 2008, and is hereby incorporated by reference.

### FEDERALLY SPONSORED RESEARCH OR DEVELOPMENT

Not Applicable.

### TECHNICAL FIELD

The present invention generally relates to a power tool. More specifically, the present invention relates to an electric pruner for trimming branches and tree limbs.

### BACKGROUND OF THE INVENTION

Generally, pruners can be used to cut or trim branches and tree limbs. Because of the continued development of landscaping, the pruner will continue to be an important gardening tool.

Most current pruners are manually operated, resembling shears and require a significant amount of force from a user. There is also a type of electric shears available having a pair of swing blades driven by a motor for cutting branches. The blades of the electric shears are usually short to reduce momentum which increases the efficiency of motor. However, when in use, when the user wants to cut high tree limbs, the lower blade of the electric shears is often screened by either other tree limbs or the main body of the shears. As a result, it is difficult for user to focus on a specific limb and may result in the cutting of an incorrect limb.

### SUMMARY OF THE INVENTION

It is a general object of the present invention to provide an electric pruner for cutting branches, tree limbs, and the like.

In one form, the present invention provides a pruner having a housing, a motor mounted in the housing, a handle, an upper blade, a lower blade, and a guide apparatus. The guide apparatus is a long shaped piece having a portion which has the same angle of curvature as the cutting blade. However, the guide apparatus is longer than the blade. In another embodiment, the guide apparatus may be formed as an extension of the blade.

The pruner provided by the present invention provides improved user guiding, which helps a user identify a specific tree limb and prevents an incorrect cutting of a limb. If the guide apparatus is not required, the guide apparatus may be easily removed.

Additional benefits and advantages of the present invention will become apparent to those skilled in the art to which this invention relates from a reading of the subsequent description of the preferred embodiment and the appended claims, taken in conjunction with the accompanying drawings.

### BRIEF DESCRIPTION OF THE DRAWINGS

Additional advantages and features of the present invention will become apparent from the subsequent description and the appended claims, taken in conjunction with the accompany drawings, wherein:

FIG. 1 is a perspective view illustrating a pruner constructed in accordance with the teachings of a preferred embodiment of the present invention;

FIG. 2 is an exploded view of the pruner of FIG. 1

FIG. 3 is a perspective view illustrating the pruner of FIG. 1 without the guide apparatus;

FIG. 4 is an exploded view of the pruner of an other embodiment;

### DETAILED DESCRIPTION

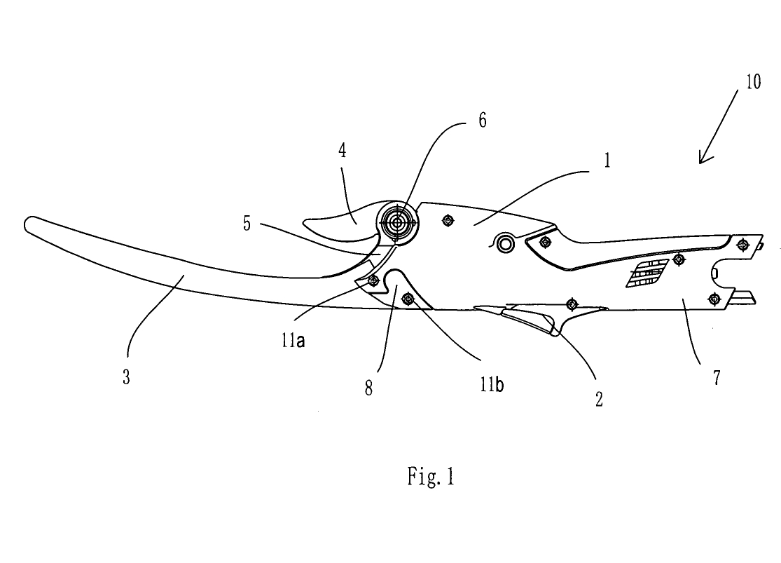

With reference to the drawings, a pruner constructed in accordance with the a preferred embodiment of the present invention is illustrated and generally identified at reference numeral 10. As shown in FIG. 1, the pruner 10 has a housing 1, a handle 7, a switch 2, a shield 8, an upper blade 4, a lower blade 5, and a guide apparatus 3. The pruner may be driven by a battery pack or by an AC electrical source.

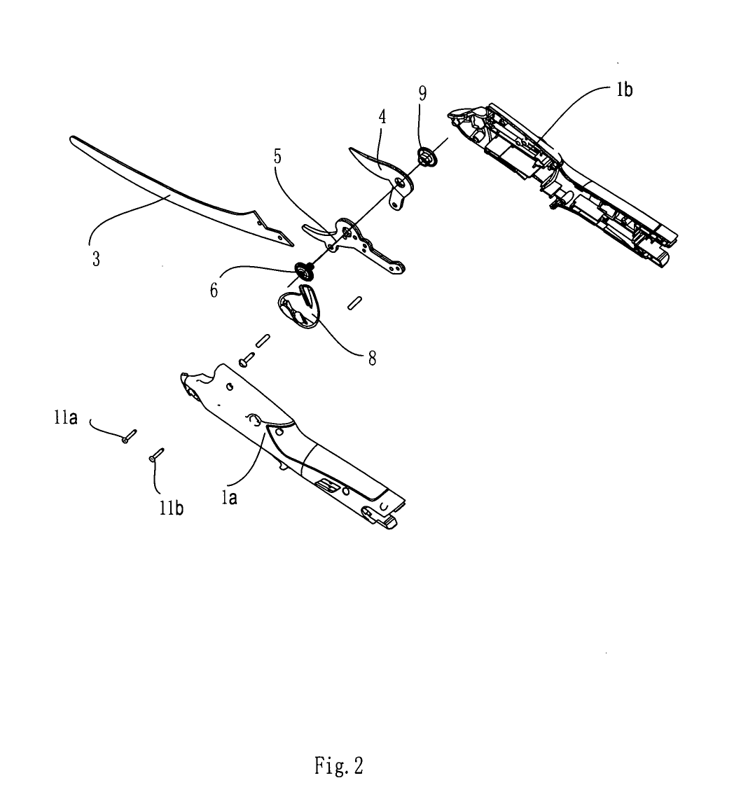

FIG. 2 is an exploded view of the pruner 10. Housing 1 is comprised of a left housing 1a and a right housing 1b. Lower blade 5 and upper blade 4 are secured using an axle bolt 6 and a blade hinge 9. When the switch 2 is pressed by user, the motor drives the reciprocating upper blade 4 about the blade hinge 9, which results in the cutting of branches or tree limbs.

As shown in FIGS. 1 and 2, the guide apparatus 3 is fastened between left housing 1 a and lower blade 5 by bolts 11a and 11b. The guide apparatus 3 has a portion close to blade hinge 9 has the same angle of curvature as lower blade 5. As a result, when the guide apparatus 3 is assembled, the guide apparatus 3 will be in alignment with the lower blade 5. Due to the alignment, the tree limb is able to slide smoothly from the portion of guide apparatus 3 away from blade hinge 9 towards the opening of upper blade 4 and lower blade 5.

The pruner 10 is in the guiding mode when the guide apparatus 3 is assembled. When the pruner 10 is in guiding mode, the guide apparatus 3 may be seen behind the tree limb to be cut and may be used as a guide for cutting. When the guide apparatus 3 is not being used as a guide, the guide apparatus 3 is curved so that a tree limb may slide smoothly into the work area of upper blade 4 and lower blade 5 to allow for cutting or trimming.

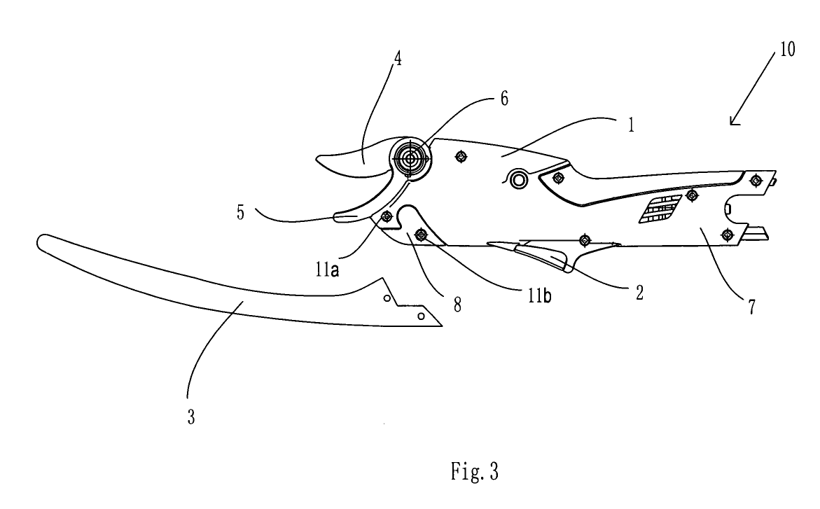

As shown in FIG. 3, the pruner 10 is in the normal mode when the guide apparatus 3 is not assembled. A shield 8 is secured to the housing 1 of pruner 10 by bolt 11b. As a result, the pruner 10 may be used separately. The guide apparatus 3 can be removed from pruner 10 by unscrewing bolts 11 a, 11b, and dismounting shield 8. When the shield 8 is removed, the pruner 10 become a normal pruner. The pruner 10 may then be used to cut lower tree limbs, in confined spaces or like.

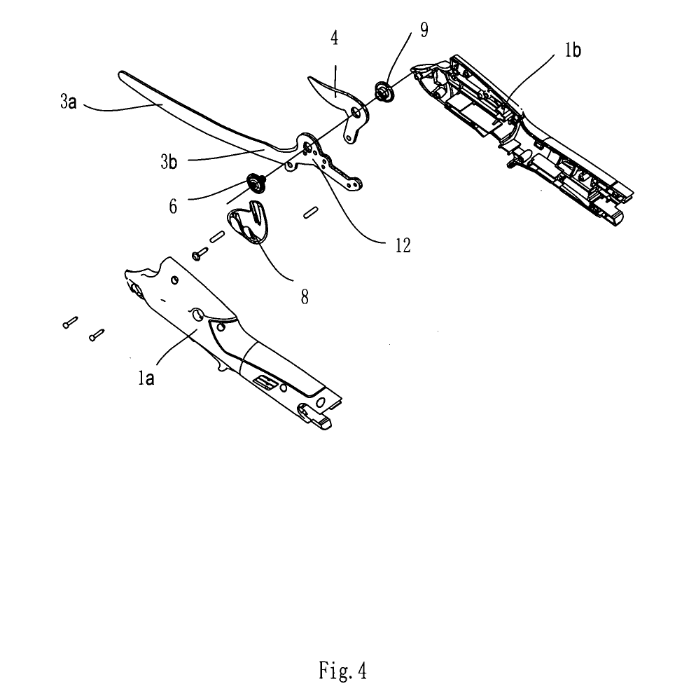

FIG. 4 is an exploded view of the pruner of another embodiment. The lower blade 12 provides an extended guide portion 3a, and blade portion 3b. When the switch is turned on, the upper blade 4 is driven by a motor to reciprocate axial about the blade hinge 9, and in combination with the blade portion 3b cuts limbs. Both the guide portion 3a and blade portion 3b are curved to allow the tree limb to be cut to slide smoothly into the work area. Because the lower blade 12 is longer, the guide portion 3a may be seen behind the tree limb to be cut and can be used as a guide for cutting.

While the invention has been described in the specification and illustrated in the drawings with reference to a preferred embodiment, it will be understood by those skilled in the art that various changes may be made and equivalents may be substituted for elements thereof without departing from the scope of the invention as defined in the claims. In addition, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the description of the appended claims.

What is claimed is:

1. A pruner, comprising:
a housing having a left section and a right section;
a motor mounted in the housing;
a handle for a user;
an upper blade;
a lower blade, wherein the lower blade is secured to the upper blade using an axle bolt; and,
a removeably fastened guide apparatus.

2. The pruner of claim 1, wherein when the motor is turned on, the upper blade is driven by the motor to rotate about the axis formed by axle bolt.

3. The pruner of claim 1, wherein the motor is driven by a battery pack.

4. The pruner of claim 1, wherein the motor is driven by an AC electrical source.

5. The pruner of claim 1, wherein the guide apparatus is removeably fastened between the left section and the right section of the housing.

6. The pruner of claim 1, wherein the guide apparatus is a longer than the upper blade.

7. The pruner of claim 1, wherein the guide apparatus is removeably fastened to the upper blade.

8. The pruner of claim 1, wherein the guide apparatus is removeably fastened to the lower blade.

9. The pruner of claim 1, wherein at least a portion of the guide apparatus has the same angle of curvature as the lower blade.

10. The pruner of claim 1, wherein the guide apparatus is formed as an extension of the lower blade.

11. The pruner of claim 1, wherein the guide apparatus if formed as an extension of the upper blade.

12. The pruner of claim 1, wherein when the pruner is in a guiding mode, the guide apparatus may be seen behind a tree limb and may be used to guide the user.

13. The pruner of claim 1, wherein when the pruner is in a normal mode, the guide apparatus is removed and the user may use the pruner to cut lower tree limbs.
